(19) United States
(12) Patent Application Publication
(10) Pub. No.: US 2026/0287040 A1
(43) Pub. Date: Sep. 24, 2026

(54) ACTIVE VIBRATION ISOLATION DEVICE

(71) Applicant: HONDA MOTOR CO., LTD., Tokyo (JP)

(72) Inventors: Yuho ITO, Wako-shi (JP); Toshio INOUE, Wako-shi (JP)

(21) Appl. No.: 19/570,950

(22) Filed: Mar. 18, 2026

(30) Foreign Application Priority Data
Mar. 21, 2025 (JP) 2025-047123

(51) Int. Cl. F16F 15/03; F16F 9/53

(52) U.S. Cl. CPC F16F 15/03; F16F 9/535; F16F 2222/06; F16F 2224/045

(57) ABSTRACT

An active vibration isolation device includes an outer hollow cylinder, an inner hollow cylinder inward of the outer hollow cylinder, an electromagnetic coil generating a magnetic field, and a magnetic body where a magnetic path is formed by the magnetic field. A first flexible member partitions a first chamber filled with magnetic viscoelastic fluid and a third chamber filled with non-magnetic liquid, and a second flexible member partitions a second chamber filled with magnetic viscoelastic fluid and a fourth chamber filled with non-magnetic liquid. The third chamber is between the outer and inner hollow cylinders and can be pushed in a transverse direction, and the fourth chamber is radially outward of the third chamber and can be pushed in an axial direction. Part of the first chamber and part of the second chamber form a flow channel for the magnetic viscoelastic fluid located above the magnetic path.

### BACKGROUND OF THE INVENTION

### 1. Field of the Invention

The present invention relates to an active vibration isolation device.

### 2. Description of the Related Art

In recent years, efforts have been actively put into sustainably providing access to a transport system, considering vulnerable road users such as elderly and disabled people and children. To achieve this, efforts are dedicated to research and development for a further improvement of transportation safety and convenience through development related to vehicle occupant comfort.

Active vibration isolation devices for use in subframe mounts, suspension bushes, or the like have heretofore been proposed with an aim to improve vehicle occupant comfort by suppressing sound, vibration, and the like in the passenger compartment (see JP2024-091252A for an example). Specifically, this active vibration isolation device includes an outer hollow cylinder, an inner hollow cylinder situated at the inner circumferential side of the outer hollow cylinder, and a liquid chamber formed between the outer and inner hollow cylinders and filled with magnetic viscoelastic fluid. The active vibration isolation device further includes an orifice flow channel in part of the liquid chamber to allow the magnetic viscoelastic fluid to flow therethrough and an electromagnetic coil forming a magnetic path extending in a direction orthogonal to the orifice flow channel.

In this active vibration isolation device, when an external force such as a load or a vibration is inputted to at least one of the outer and inner hollow cylinders in a direction perpendicular to their axis (a transverse direction), the magnetic viscoelastic fluid tries to flow through the orifice flow channel. In this event, the active vibration isolation device controls the flow of the magnetic viscoelastic fluid by varying the magnetic field generated by the electromagnetic coil. The active vibration isolation device thereby exhibits flexible damping characteristics according to the magnitude of the external force inputted.

However, a conventional active vibration isolation device (see JP2024-091252A for an example) is insufficient in its vibration isolation performance against an external force such as a vibration inputted in an axial direction.

### SUMMARY OF THE INVENTION

Thus, the present invention has an objective to provide an active vibration isolation device that exhibits favorable damping characteristics against both an external force inputted in the axial direction and an external force inputted in the transverse direction.

An active vibration isolation device achieving the above objective is an active vibration isolation device including: an outer hollow cylinder; an inner hollow cylinder situated at an inner circumferential side of the outer hollow cylinder; a magnetic field generation portion configured to generate a magnetic field; a magnetic body where a magnetic path is formed by the magnetic field; a first liquid chamber and a second liquid chamber that are filled with magnetic viscoelastic fluid; a third liquid chamber adjacent to the first liquid chamber in an axial direction of the inner hollow cylinder and filled with non-magnetic liquid; and a fourth liquid chamber adjacent to the second liquid chamber in the axial direction of the inner hollow cylinder and filled with non-magnetic liquid. The first liquid chamber and the third liquid chamber are partitioned by a first flexible member, and the second liquid chamber and the fourth liquid chamber are partitioned by a second flexible member. A first one of the third liquid chamber and the fourth liquid chamber is provided between the outer hollow cylinder and the inner hollow cylinder so as to be able to be pushed in a transverse direction perpendicular to the axial direction, and a second one of the third liquid chamber and the fourth liquid chamber is provided radially outward of the outer hollow cylinder so as to be able to be pushed in the axial direction. Part of the first liquid chamber and part of the second liquid chamber form a flow channel for the magnetic viscoelastic fluid located above the magnetic path.

The active vibration isolation device of the present invention can exhibit favorable damping characteristics against both an external force inputted in the axial direction and an external force inputted in the transverse direction.

### BRIEF DESCRIPTION OF THE DRAWINGS

FIG. 1 is an overall perspective view of a subframe having an active vibration isolation device according to an embodiment of the present invention.

FIG. 2 is an overall perspective view of the active vibration isolation device according to the embodiment of the present invention.

FIG. 3A is a plan view of the active vibration isolation device according to the embodiment of the present invention.

FIG. 3B is a side view of the active vibration isolation device according to the embodiment of the present invention.

FIG. 4 is an exploded perspective view of the active vibration isolation device according to the embodiment of the present invention.

FIG. 5A is a partial perspective view of the active vibration isolation device including a VA-VA section in FIG. 3A.

FIG. 5B is a partial perspective view of the active vibration isolation device including a VB-VB section in FIG. 3A.

FIG. 5C is a partial perspective view of the active vibration isolation device including a VC-VC section in FIG. 3A.

FIG. 6A is a partial perspective view of the active vibration isolation device including a VIA-VIA section in FIG. 3B.

FIG. 6B is a partial perspective view of the active vibration isolation device including a VIB-VIB section in FIG. 3B.

FIG. 7 is a partial perspective view of the active vibration isolation device including a VII-VII section in FIG. 5B.

FIG. 8A is a diagram illustrating how the active vibration isolation device operates when an external force is inputted in a transverse direction of the active vibration isolation device.

FIG. 8B is a diagram illustrating the operation of the active vibration isolation device, showing how magnetic viscoelastic fluid flows in a first liquid chamber when an external force is inputted in the transverse direction of the active vibration isolation device.

FIG. 8C is a diagram illustrating the operation of the active vibration isolation device 1, showing how a magnetic path is formed by the magnetic field generated by a first magnetic field generation portion.

FIG. 9 is a schematic diagram showing how magnetic particles behave when a magnetic field is exerted to a flow channel for magnetic viscoelastic fluid.

FIG. 10A is a diagram illustrating how the active vibration isolation device operates when an external force is inputted in an axial direction of the active vibration isolation device.

FIG. 10B is a diagram illustrating the operation of the active vibration isolation device 1, showing how magnetic viscoelastic fluid flows in a second liquid chamber when an external force is inputted in the axial direction of the active vibration isolation device.

FIG. 10C is a diagram illustrating how a magnetic path is formed by the magnetic field generated by a second magnetic field generation portion.

FIG. 11A is a diagram showing a first state of the magnetic path that can be formed by the magnetic fields generated by the first magnetic field generation portion and the second magnetic field portion.

FIG. 11B is a diagram showing a second state of the magnetic path that can be formed by the magnetic field generated by the second magnetic field portion.

FIG. 11C is a diagram showing a third state of the magnetic path that can be formed by the magnetic fields generated by the first magnetic field generation portion and the second magnetic field portion.

FIG. 11D is a diagram showing a fourth state of the magnetic path that can be formed by the magnetic fields generated by the first magnetic field generation portion and the second magnetic field portion.

FIG. 12 is a partial perspective view of an active vibration isolation device according to a first modification.

FIG. 13 is a partial perspective view of an active vibration isolation device according to a second modification.

### DETAILED DESCRIPTION OF THE EMBODIMENTS

Next, a mode for carrying out an active vibration isolation device of the present invention (an embodiment of the active vibration isolation device) is described in detail with reference to the drawings as needed.

Although the active vibration isolation device is applied to a vehicle subframe in the example below, the present invention is not limited to this. The active vibration isolation device of the present invention may also be applied to, for example, a vehicle sound/vibration isolation device, such as a mount bush, situated between a vehicle body frame and a member connected to the vehicle body frame, a damper situated between vehicle members, or the like. First, the overall configuration of the subframe to which the active vibration isolation device of the present embodiment is applied is described, and then, the active vibration isolation device is described in more detail.

### Subframe

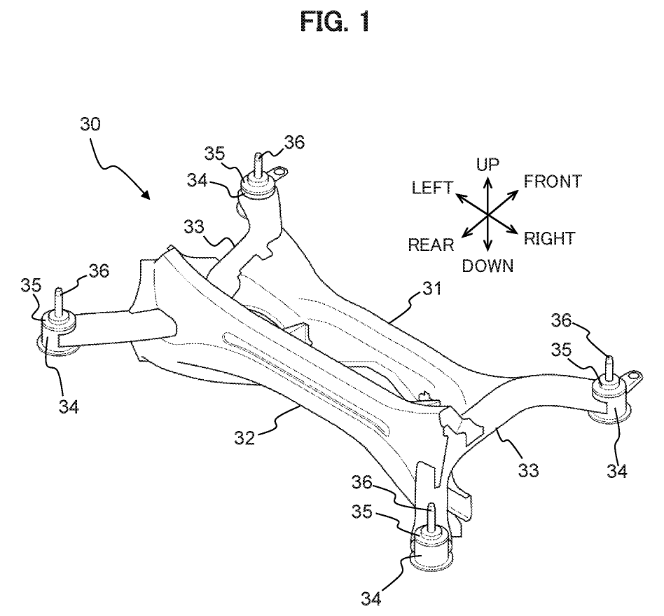

FIG. 1 is an overall perspective view of a subframe having the active vibration isolation device according to the embodiment of the present invention. Note that the directions "up", "down", "left", "right", "front", and "rear" used in the following descriptions are based on the arrowed directions in FIG. 1 corresponding to the up, down, left, right, front, and rear directions of the vehicle.

A subframe 30 shown in FIG. 1 is attached to a vehicle body side such as a rear side frame (not shown) of the vehicle and structured to support a suspension arm (not shown).

As shown in FIG. 1, the subframe 30 is in the shape of a number sign in a plan view.

Specifically, the subframe 30 includes a front cross member 31 extending in a vehicle width direction (a left-right direction), a rear cross member 32 located rearward of the front cross member 31 and extending in the vehicle width direction (the left-right direction), and a pair of left and right side members 33 extending in the front-rear direction and connected to the respective vehicle-width-direction end portions of the front cross member 31 and the respective vehicle-width-direction end portions of the rear cross member 32.

In a plan view, the side members 33 are each curved to protrude inward in the vehicle width direction. More specifically, the side members 33 are each curved so that the more frontward it goes from its joint portion with the front cross member 31, the more outward it changes in position in the vehicle width direction. Similarly, the side members 33 are each curved so that the more rearward it goes from its joint portion with the rear cross member 32, the more outward it changes in position in the vehicle width direction.

The front and rear end portions of each of the side members 33 each have a collar member 34 attached thereto by welding or the like.

The collar member 34 is configured as a hollow cylindrical body opening at its top and bottom. A bush 35 is inserted through the collar member 34. The bush 35 is fixed to the collar member 34 by welding or the like.

The bush 35 has a spindle 36 protruding upward and fastened to a rear side frame (not shown). Thus, the subframe 30 is supported by the rear side frame (not shown) in a floating manner via the bush 35.

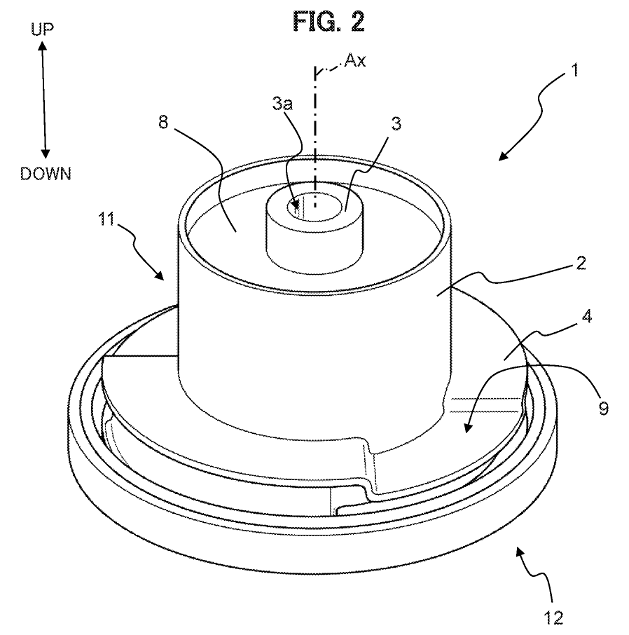

The bush 35 is the active vibration isolation device of the present embodiment and is hereinafter referred to as an active vibration isolation device 1. Note that the spindle 36 is inserted through a hole portion 3a (see FIG. 2) of an inner hollow cylinder 3 (see FIG. 2) to be described later and supported.

### Active Vibration Isolation Device

The active vibration isolation device 1 of the present embodiment electromagnetically varies the flow resistance of magnetic viscoelastic fluid in a predetermined liquid chamber according to the magnitude of an inputted external force such as a load or vibration (hereinafter also referred to simply as "such as a vibration"). The active vibration isolation device 1 thus actively exhibits damping characteristics against the external force. The active vibration isolation device 1 of the present embodiment has a first liquid chamber and a second liquid chamber filled with magnetic viscoelastic fluid. The active vibration isolation device 1 also has third liquid chambers filled with non-magnetic liquid that transmits an external force such as a vibration inputted in a transverse direction to the magnetic viscoelastic fluid in the first liquid chamber and fourth liquid chambers filled with non-magnetic liquid that transmits an external force such as a vibration inputted in an axial direction to the magnetic viscoelastic fluid in the second liquid chamber. The active vibration isolation device 1 is described in detail below.

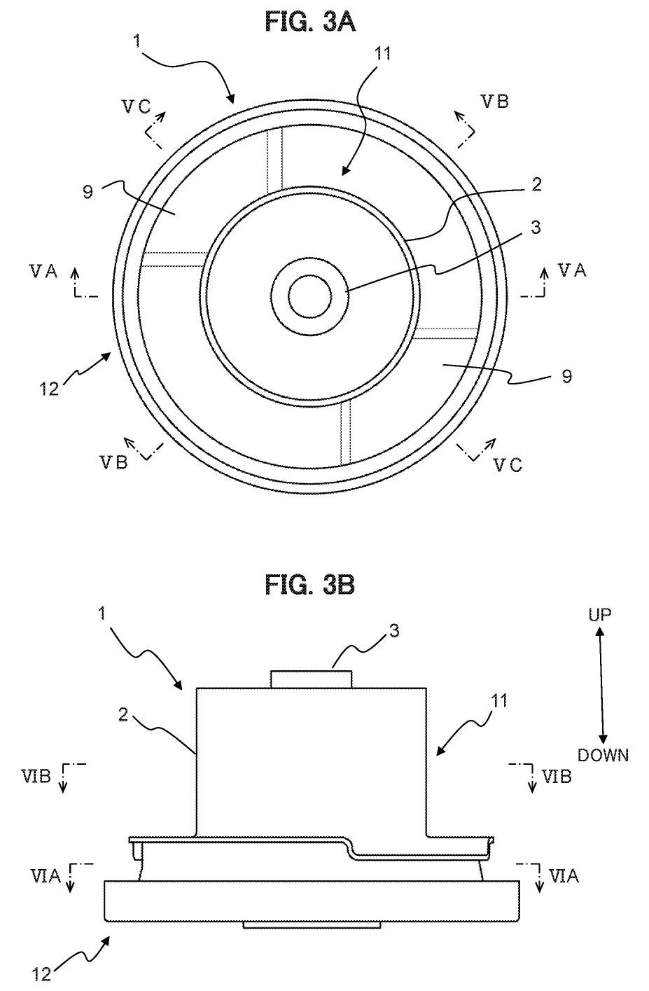

FIG. 2 is an overall perspective view of the active vibration isolation device 1 according to the present embodiment. FIG. 3A is a plan view of the active vibration isolation device 1 according to the present embodiment. FIG. 3B is a side view of the active vibration isolation device 1 according to the present embodiment.

As shown in FIG. 2, the active vibration isolation device 1 has an external shape resembling a hat. Specifically, the active vibration isolation device 1 has a crown portion 11 and a brim portion 12 constituting the hat shape.

A direction along an axis Ax of the hat-shaped active vibration isolation device 1 shown in FIG. 2 may be referred to simply as an "axial direction" hereinbelow, and a direction perpendicular to the axis Ax of the active vibration isolation device 1 may be referred to simply as a "transverse direction" hereinbelow. Also, a direction along the radius of the active vibration isolation device 1 may be referred to simply as a "radial direction," and a direction along the circumference of the active vibration isolation device 1 may be referred to simply as a "circumferential direction."

As shown in FIGS. 3A and 3B, the crown portion 11 has a columnar shape. The brim portion 12 has a disk shape. Note that detailed descriptions will be given later of sections taken along lines VA-VA, VB-VB, and VC-VC in FIG. 3A and the sections taken along lines VIA-VIA and VIB-VIB in FIG. 3B.

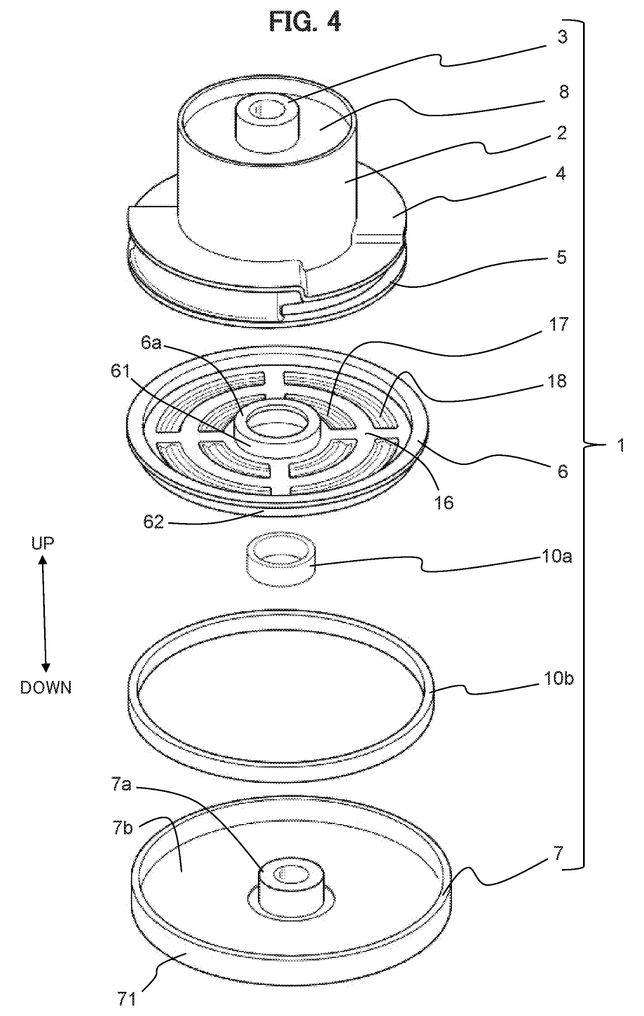

FIG. 4 is an exploded perspective view of the active vibration isolation device 1.

As shown in FIG. 4, the active vibration isolation device 1 includes an outer hollow cylinder 2, an outer-hollow-cylinder flange 4, an inner hollow cylinder 3, an inner-hollow-cylinder flange 5, and an elastic body 8.

The active vibration isolation device 1 further includes, as shown in FIG. 4, a first flexible member 17, a second flexible member 18, a first magnetic body 6, a second magnetic body 7, a first electromagnetic coil 10a (a first magnetic field generation portion; the same applies below), and a second electromagnetic coil 10b (a second magnetic field generation portion; the same applies below).

Referring back to FIG. 2, the outer hollow cylinder 2 is formed as a hollow cylindrical body. The outer hollow cylinder 2 forms a circumferential wall of the crown portion 11.

The outer-hollow-cylinder flange 4 is formed of an annular plate body extending radially outward like a brim from one end of the outer hollow cylinder 2 in terms of the direction of the axis Ax. The outer-hollow-cylinder flange 4 is integrally formed with the outer hollow cylinder 2.

As shown in FIG. 2, depressed portions 9 are formed at the outer-hollow-cylinder flange 4.

The depressed portions 9 each form a step whose bottom surface is a flat surface depressed downward from the general portion of the outer-hollow-cylinder flange 4.

In a plan view shown in FIG. 3A, the depressed portions 9 each have a fan shape, becoming wider and wider from the inner circumferential side to the outer circumferential side at an angle of 90 degrees. The depressed portions 9 of the present embodiment are provided at two locations facing each other in a plan view shown in FIG. 3A.

The inner hollow cylinder 3 is situated at the inner circumferential side of the outer hollow cylinder 2, as shown in FIG. 2.

As shown in FIG. 3A, the inner hollow cylinder 3 is formed as a hollow cylindrical body and is situated concentrically with the outer hollow cylinder 2.

As shown in FIG. 3B, the inner hollow cylinder 3 protrudes upward slightly from the outer hollow cylinder 2.

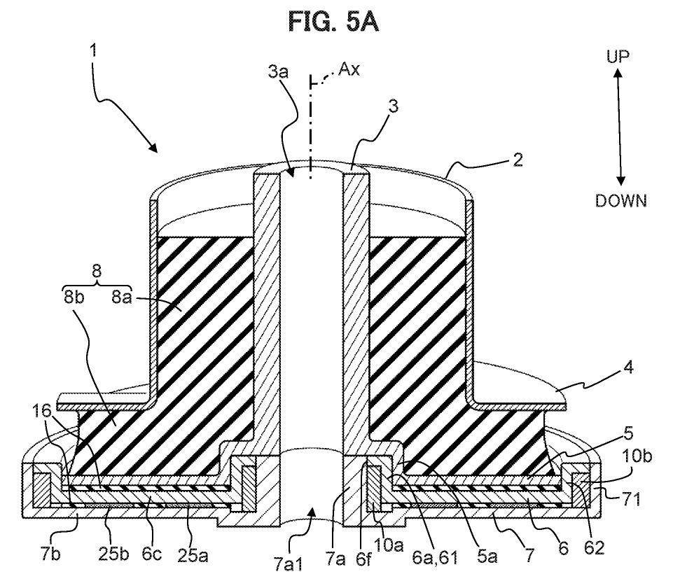

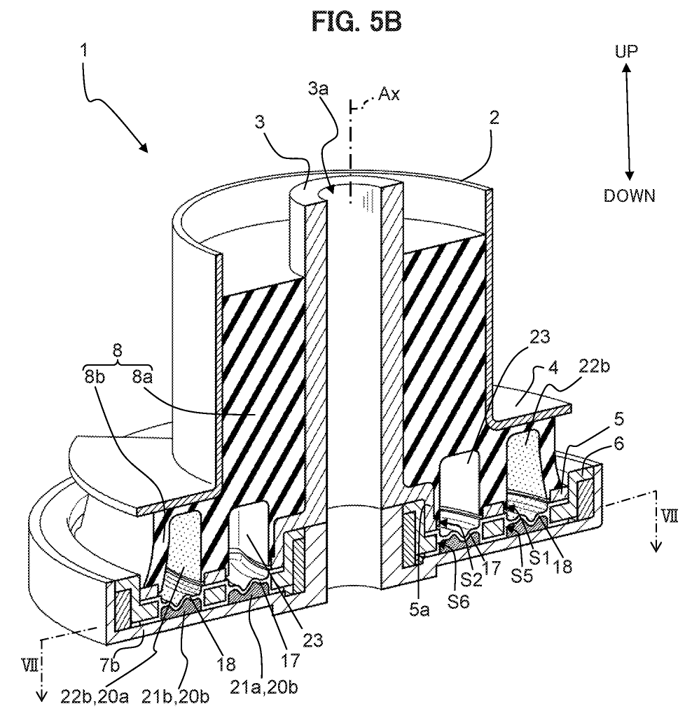

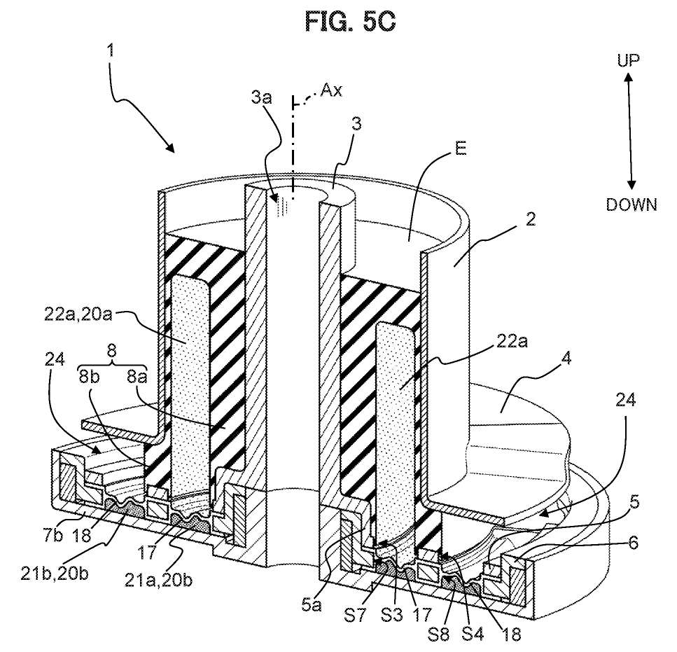

FIG. 5A is a partially exploded view of the active vibration isolation device including the VA-VA section in FIG. 3A. FIG. 5B is a partially exploded view of the active vibration isolation device including the VB-VB section in FIG. 3A. FIG. 5C is a partially exploded view of the active vibration isolation device including the VC-VC section in FIG. 3A.

As shown in FIG. 5A, the inner-hollow-cylinder flange 5 is formed as an annular plate body extending radially outward like a brim from one end of the inner hollow cylinder 3 in terms of the direction of the axis Ax. The inner-hollow-cylinder flange 5 is integrally formed with the inner hollow cylinder 3.

The inner-hollow-cylinder flange 5 is situated away from the outer-hollow-cylinder flange 4 in the axial direction of the inner hollow cylinder 3.

Also, the inner-hollow-cylinder flange 5 has a stepped wall 5a on its way of extending radially outward. Specifically, the inner-hollow-cylinder flange 5, after extending radially outward by a certain distance, bends away from the outer-hollow-cylinder flange 4 to extend axially and then bends again to extend radially outward. A protruding portion 6a of the first magnetic body 6 to be described later fits on the radial inner side of the stepped wall 5a.

Also, as shown in FIG. 5B, slits S1 are formed in the inner-hollow-cylinder flange 5 to allow fourth liquid chambers 22b to face the second flexible member 18. To coincide with the fourth liquid chambers 22b, the slits S1 extend in the circumferential direction of the inner-hollow-cylinder flange 5. Detailed descriptions of the fourth liquid chambers 22b and the second flexible member 18 will be given later.

Also, as shown in FIG. 5B, slits S2 are formed in the inner-hollow-cylinder flange 5 to allow air chambers 23 to face the first flexible member 17. To coincide with the air chambers 23, the slits S2 extend in the circumferential direction of the inner-hollow-cylinder flange 5. Detailed descriptions of the air chambers 23 and the first flexible member 17 will be given later.

Also, as shown in FIG. 5C, slits S3 are formed in the inner-hollow-cylinder flange 5 to allow third liquid chambers 22a to face the first flexible member 17. To coincide with the third liquid chambers 22a, the slits S3 extend in the circumferential direction of the inner-hollow-cylinder flange 5. A detailed description of the third liquid chambers 22a will be given later.

Also, as shown in FIG. 5C, the inner-hollow-cylinder flange 5 has slits S4 to allow outer-rim depressed portions 24 of the elastic body 8 to face the second flexible member 18. To coincide with the outer-rim depressed portions 24, the slits S4 extend in the circumferential direction of the inner-hollow-cylinder flange 5. A detailed description of the outer-rim depressed portions 24 will be given later.

The outer hollow cylinder 2, the inner hollow cylinder 3, the outer-hollow-cylinder flange 4, and the inner-hollow-cylinder flange 5 are assumed to be formed of a non-magnetic material.

Examples of the non-magnetic material include, but are not limited to, aluminum alloys, non-ferritic SUS, and copper.

As shown in FIG. 5A, the elastic body 8 of the present embodiment is assumed to be made of a synthetic rubber having an external shape resembling a hat.

As shown in FIG. 5A, at a crown portion 8a of the hat shape, the elastic body 8 joins the outer hollow cylinder 2 and the inner hollow cylinder 3 integrally by vulcanized adhesion. Also, at a brim portion 8b of the hat shape, the elastic body 8 joins the outer-hollow-cylinder flange 4 and the inner-hollow-cylinder flange 5 by vulcanized adhesion with the outer-hollow-cylinder flange 4 and the inner-hollow-cylinder flange 5 spaced away from each other by a predetermined distance.

The elastic body 8 thus configured has the following components formed therein: the third liquid chambers 22a (see FIG. 5C), the fourth liquid chambers 22b (see FIG. 5B), the air chambers 23 (see FIG. 5B), and the outer-rim depressed portions 24 (see FIG. 5C).

Before giving descriptions of a first liquid chamber 21a and a second liquid chamber 21b shown in FIG. 5B, first, descriptions are given of the third liquid chambers 22a (see FIG. 5C), the fourth liquid chambers 22b (see FIG. 5B), the air chambers 23 (see FIG. 5B), and the outer-rim depressed portions 24 (see FIG. 5C).

As shown in FIG. 5C, the third liquid chambers 22a are each a three-dimensional closed region extending long axially inside the elastic body 8. Specifically, the third liquid chamber 22a extends inside the elastic body 8 located along the outer circumferential side of the inner hollow cylinder 3 and the outer circumferential side of the stepped wall 5a of the inner-hollow-cylinder flange 5, with one end of the third liquid chamber 22a reaching close to an axial exposed end surface E of the elastic body 8 and the other end facing the first flexible member 17 as described earlier.

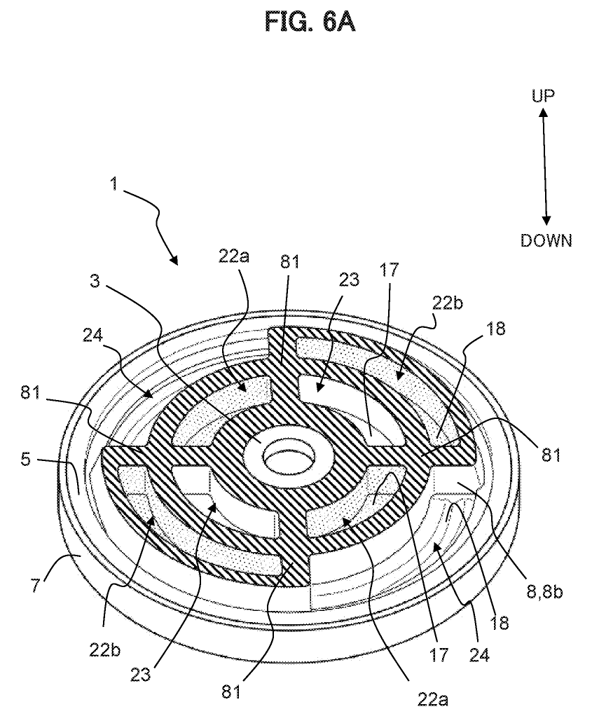

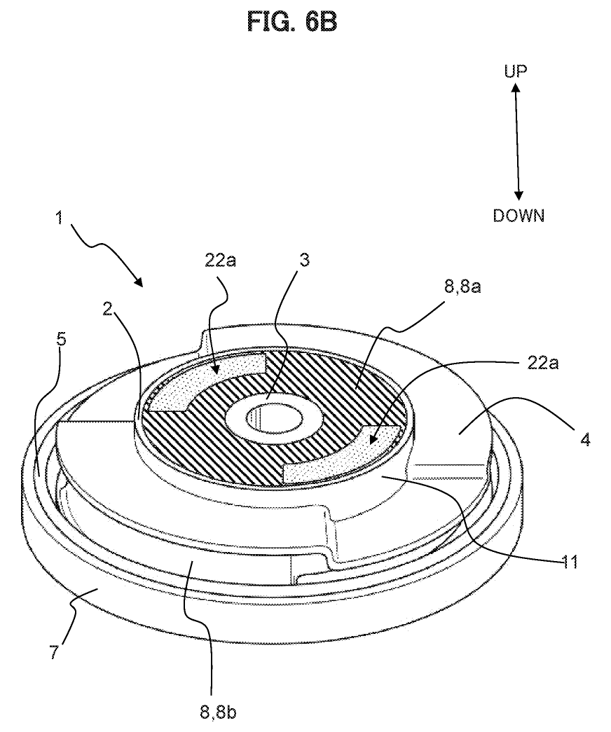

FIG. 6A is a partial perspective view of the active vibration isolation device 1 including the VIA-VIA section in FIG. 3B. FIG. 6A includes a cross section of the brim portion 8b constituting the hat-shaped elastic body 8. FIG. 6B is a partial perspective view of the active vibration isolation device 1 including the VIB-VIB section in FIG. 3B. FIG. 6B includes a cross section of the crown portion 8a constituting the hat-shaped elastic body 8.

As shown in FIG. 6A, the third liquid chambers 22a of the present embodiment are formed as a pair facing each other with the inner hollow cylinder 3 in between and each extending circumferentially on the outer circumferential side of the inner hollow cylinder 3, forming an arc shape in a plan view of the cross section of the elastic body 8.

Specifically, the pair of third liquid chambers 22a are formed at two of four regions of the elastic body 8 divided circumferentially at 90-degree intervals by four partitioning portions 81 formed at the elastic body 8, the two regions facing each other radially.

The other two regions facing each other among the four regions divided at 90-degree intervals are the air chambers 23 to be described later. Thus, the third liquid chambers 22a and the air chambers 23 are formed alternately in the circumferential direction.

Note that in FIG. 6A, reference numeral 17 denotes the first flexible member, reference numeral 18 denotes the second flexible member, reference numeral 5 denotes the inner-hollow-cylinder flange, and reference numeral 7 denotes the second magnetic body.

Then, as shown in FIG. 6B, at the crown portion 11 of the active vibration isolation device 1, the pair of third liquid chambers 22a are formed within the elastic body 8 at positions closer to the inner circumferential surface of the outer hollow cylinder 2 than to the outer circumferential surface of the inner hollow cylinder 3.

Note that in FIG. 6B, reference numeral 4 denotes the outer-hollow-cylinder flange, reference numeral 7 denotes the second magnetic body, reference numeral 5 denotes the inner-hollow-cylinder flange, reference numeral 8a denotes the crown portion of the hat-shaped elastic body 8, and reference numeral 8b denotes the brim portion of the hat-shaped elastic body 8.

Next, a description is given of the fourth liquid chambers 22b (see FIG. 5B).

As shown in FIG. 5B, the fourth liquid chambers 22b are formed within the brim portion 8b of the elastic body 8 situated between the outer-hollow-cylinder flange 4 and the inner-hollow-cylinder flange 5.

The fourth liquid chambers 22b are each substantially rectangular as seen in a sectional view crossing the fourth liquid chamber 22b in the radial direction.

As described earlier, the fourth liquid chambers 22b face the second flexible member 18.

As shown in FIG. 6A, the fourth liquid chambers 22b of the present embodiment are formed as a pair formed along the circumference more circumferentially outward than the third liquid chambers 22a and facing each other with the inner hollow cylinder 3 interposed in between. The fourth liquid chambers 22b of the present embodiment each extend circumferentially, forming an arc shape in a plan view of the cross section of the elastic body 8 shown in FIG. 6A.

Specifically, the pair of fourth liquid chambers 22b are formed at two of four regions of the elastic body 8 divided circumferentially at 90-degree intervals by four partitioning portions 81 formed at the elastic body 8, the two regions facing each other radially.

The fourth liquid chambers 22b are formed with a phase shifted from the third liquid chambers 22a circumferentially by 90 degrees.

The third liquid chambers 22a and the fourth liquid chambers 22b thus configured are filled with non-magnetic liquid.

There are no particular limitations as to the non-magnetic liquid as long as it is non-magnetic, incompressible liquid. The present embodiment assumes that the non-magnetic liquid is hydraulic oil (such as silicone oil or ester oil) typically used as a pressure transmitting medium, but is not limited to this.

Next, a description is given of the air chambers 23 (see FIG. 5B).

As shown in FIG. 5B, the air chambers 23 are formed within the elastic body 8 at its portion located on the outer circumferential side of the stepped wall 5a of the inner-hollow-cylinder flange 5. The air chambers 23 are closed spaces formed in the elastic body 8 at locations closer to the inner circumferential side than the fourth liquid chambers 22b are.

As shown in FIG. 5B, the air chambers 23 are each substantially rectangular as seen in a sectional view crossing the air chamber 23 in the radial direction.

Referring back to FIG. 6A, the air chambers 23 each form an arc shape and are formed on the outer circumferential side of the inner hollow cylinder 3 alternately with the third liquid chambers 22a in the circumferential direction.

The air chambers 23 thus configured are assumed to be filled with a compressible medium (such as air) that varies in volume as the pressure changes.

Next, a description is given of the outer-rim depressed portions 24 (see FIG. 5C).

As shown in FIG. 5C, the outer-rim depressed portions 24 are formed between the outer-hollow-cylinder flange 4 and the inner-hollow-cylinder flange 5. Specifically, the outer-rim depressed portions 24 are each formed by denting part of the brim portion 8b of the elastic body 8 radially inward, the part being located between the outer-hollow-cylinder flange 4 and the inner-hollow-cylinder flange 5.

As shown in FIG. 6A, the outer-rim depressed portions 24 thus configured are formed at the outer circumferential side of the third liquid chambers 22a.

The outer-rim depressed portions 24 are formed as a pair of arc-shaped dents arranged alternately with the fourth liquid chambers 22b in the circumferential direction.

The outer-rim depressed portions 24 thus configured allow the second flexible member 18 to face the atmosphere.

Next, descriptions are given of the first magnetic body 6 (see FIG. 4), the first flexible member 17 (see FIG. 4) supported by the first magnetic body 6, and the second flexible member 18 (see FIG. 4).

As shown in FIG. 4, the first magnetic body 6 is disk-shaped.

The first magnetic body 6 has the hollow cylindrical protruding portion 6a formed at the center by an annular first vertical wall 61 and an annular second vertical wall 62 provided upright along the outer circumferential edge.

As shown in FIG. 5A, the first magnetic body 6 is located at an opposite side of the inner-hollow-cylinder flange 5 from the side where the elastic body 8 is joined by vulcanized adhesion. The first magnetic body 6 is formed by, for example, iron, cobalt, nickel, or any of their alloys.

The protruding portion 6a of the first magnetic body 6 is, as described earlier, fit on the inner circumferential side of the stepped wall 5a of the inner-hollow-cylinder flange 5.

In the sectional view in FIG. 5A, the first vertical wall 61 forming the protruding portion 6a extends from the inner circumferential edge of the first magnetic body 6 axially along the inner circumferential surface of the stepped wall 5a of the inner-hollow-cylinder flange 5 and then at the tip, bends radially inward in the shape of the letter L, forming a penetration hole 6f. This penetration hole 6f receives a hollow cylindrical portion 7a of the second magnetic body 7 to be described later.

Meanwhile, in the sectional view in FIG. 5A, the second vertical wall 62 extends from the outer circumferential edge of the first magnetic body 6 axially toward the outer-hollow-cylinder flange 4 and then at the tip, bends radially outward in the shape of the letter L, coming into contact with the inner circumferential surface of an outer wall 71 of the second magnetic body 7 to be described later.

Also, as shown in FIG. 5B, the first magnetic body 6 is provided with slits S5 extending in the circumferential direction of the first magnetic body 6, coinciding with the slits S1 in the inner-hollow-cylinder flange 5.

The second flexible member 18 is situated at the slits S5, partitioning the fourth liquid chambers 22b and the second liquid chambers 21b to be described later.

As shown in FIG. 5B, the first magnetic body 6 is also provided with slits S6 extending in the circumferential direction of the first magnetic body 6, coinciding with the slits S2 in the inner-hollow-cylinder flange 5.

The first flexible member 17 is situated at the slits S6, partitioning the air chambers 23 and the first liquid chamber 21a to be described later.

As shown in FIG. 5C, the first magnetic body 6 is also provided with slits S7 extending in the circumferential direction of the first magnetic body 6, coinciding with the slits S3 in the inner-hollow-cylinder flange 5.

The first flexible member 17 is situated at the slits S7, partitioning the third liquid chambers 22a and the first liquid chamber 21a to be described later.

As shown in FIG. 5C, the first magnetic body 6 is also provided with slits S8 extending in the circumferential direction of the first magnetic body 6, coinciding with the slits S4 in the inner-hollow-cylinder flange 5.

The second flexible member 18 is situated at the slits S8, partitioning the outer-rim depressed portions 24 and the second liquid chamber 21b to be described later.

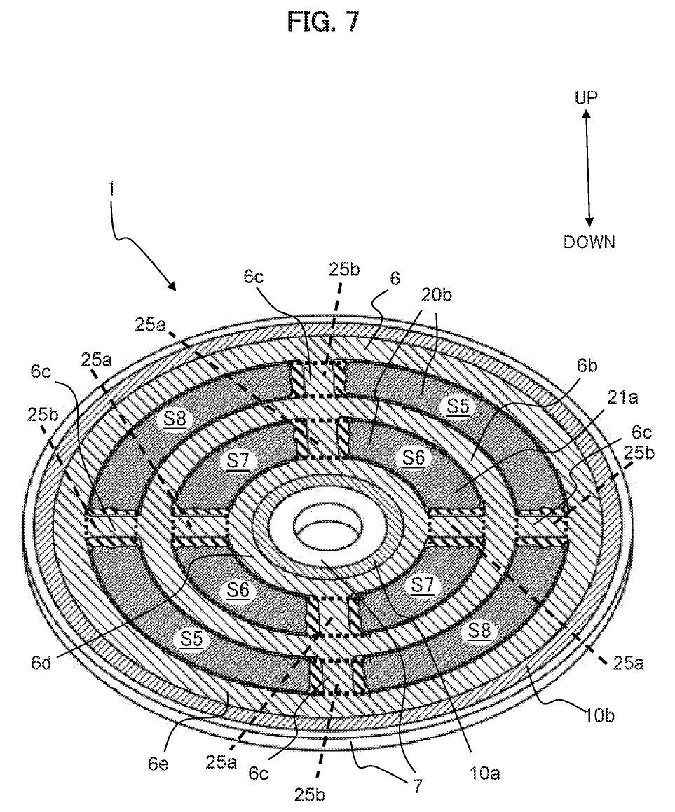

FIG. 7 is a partial perspective view of the active vibration isolation device 1 including the VII-VII section in FIG. 5B.

Reference numeral S5 in FIG. 7 denotes the slits in the first magnetic body 6 where the second flexible member 18 (see FIG. 5B) partitioning the fourth liquid chambers 22b (see FIG. 5B) and the second liquid chamber 21b (see FIG. 5B) is situated. Reference numeral S6 in FIG. 7 denotes the slits in the first magnetic body 6 where the first flexible member 17 (see FIG. 5B) partitioning the air chambers 23 (see FIG. 5B) and the first liquid chamber 21a (see FIG. 5B) is situated. Reference numeral S7 in FIG. 7 denotes the slits in the first magnetic body 6 where the first flexible member 17 (see FIG. 5C) partitioning the third liquid chambers 22a (see FIG. 5C) and the first liquid chamber 21a (see FIG. 5C) is situated. Reference numeral S8 in FIG. 7 denotes the slits where the second flexible member 18 (see FIG. 5C) partitioning the outer-rim depressed portions 24 (see FIG. 5C) and the second liquid chamber 21b (see FIG. 5C) is situated.

As shown in FIG. 7, the first magnetic body 6 has an annular partitioning portion 6b radially partitioning the slits S5 and S8 formed in the first magnetic body 6 on the outer circumferential side from the slits S6 and S7 formed in the first magnetic body 6 on the inner circumferential side.

The first magnetic body 6 also has four radially-extending partitioning portions 6c circumferentially partitioning the radially adjacent slits S5 and S6 in the first magnetic body 6 from the slits S7 and S8 in the first magnetic body 6 that are radially adjacent with a different phase from the slits S5 and S6. The four radially-extending partitioning portions 6c are arranged at 90-degree intervals.

Thus, as shown in FIG. 7, the first magnetic body 6 has an inner-circumferential-side annular portion 6d, an outer-circumferential-side annular portion 6e, the annular partitioning portion 6b, and the radially-extending partitioning portions 6c integrally connecting the inner-circumferential-side annular portion 6d, the outer-circumferential-side annular portion 6e, and the annular partitioning portion 6b.

Note that in FIG. 7, reference numeral 7 denotes the second magnetic body, reference numeral 10a denotes the first electromagnetic coil, and reference numeral 10b denotes the second electromagnetic coil.

Next, descriptions are given of the first flexible member 17 (see FIG. 4) and the second flexible member 18 (see FIG. 4). The first flexible member 17 of the present embodiment is assumed to be a thin plate formed of synthetic rubber.

As shown in FIG. 4, the first flexible member 17 and the second flexible member 18 are attached to the first magnetic body 6 by a support portion 16 formed of a thin film of synthetic rubber, which is to be described later.

As shown in FIG. 5B, the first flexible member 17 is provided to be located substantially at the centers of the slits S6 in the first magnetic body 6 in terms of the depth direction, occluding the slits S6 axially.

As shown in FIG. 5C, the first flexible member 17 is also provided to be located substantially at the centers of the slits S7 in the first magnetic body 6 in terms of the depth direction, occluding the slits S7 axially.

As shown in FIG. 5B, the second flexible member 18 is provided to be located substantially at the centers of the slits S5 in the first magnetic body 6 in terms of the depth direction, occluding the slits S5 axially.

As shown in FIG. 5C, the second flexible member 18 is provided to be located substantially at the centers of the slits S8 in the first magnetic body 6 in terms of the depth direction, occluding the slits S8 axially.

Note that in the present embodiment, the first flexible member 17 and the second flexible member 18 are disposed to undulate radially as shown in FIGS. 5B and 5C so as to be easy to warp axially.

Next, a description of the support portion 16 (see FIG. 4) is given.

As shown in FIG. 5A, the support portion 16 is formed to cover the front and back of the first magnetic body 6 except for the first vertical wall 61 and the second vertical wall 62 of the first magnetic body 6 as well as part of the radially-extending partitioning portions 6c (see FIG. 7) where first orifice flow channels 25a and second orifice flow channels 25b to be described later are to be formed.

Note that the present embodiment assumes that the first flexible member 17 (see FIG. 4), the second flexible member 18 (see FIG. 4), and the support portion 16 (see FIG. 4) are formed simultaneously in a predetermined mold by vulcanization molding so as to be integral with the first magnetic body 6 (see FIG. 4). However, the method for attaching the first flexible member 17 and the second flexible member 18 to the first magnetic body 6 is not limited to this.

Next, the second magnetic body 7 (see FIG. 4) is described.

The second magnetic body 7 is formed of, for example, iron, cobalt, nickel, or any of their alloys.

As shown in FIG. 4, the second magnetic body 7 has the hollow cylindrical portion 7a, a circular plate portion 7b extending radially outward from an axial end of the hollow cylindrical portion 7a, and the annular outer wall 71 extending from the outer edge of the circular plate portion 7b toward the outer-hollow-cylinder flange 4.

As shown in FIG. 5A, the hollow cylindrical portion 7a is designed to fit into the penetration hole 6f of the first magnetic body 6, as described earlier. The hollow cylindrical portion 7a has a hole portion 7a1 formed therein, and the hole portion 7a1 communicates with the hole portion 3a of the inner hollow cylinder 3.

Also, as shown in FIG. 5A, an annular space in which to house the first electromagnetic coil 10a is formed between the hollow cylindrical portion 7a of the second magnetic body 7 and the first vertical wall 61 of the first magnetic body 6.

Also, an annular space in which to house the second electromagnetic coil 10b is formed between the outer wall 71 of the second magnetic body 7 and the second vertical wall 62 of the first magnetic body 6.

As shown in FIG. 5A, the first magnetic body 6 (the radially-extending partitioning portions 6c) and the circular plate portion 7b of the second magnetic body 7 are magnetically isolated from each other by the above-described support portion 16 made of synthetic rubber.

Note that as shown in FIG. 5A, the support portion 16 is absent at the portions where the first orifice flow channels 25a constituting part of the first liquid chamber 21a to be described next and the second orifice flow channels 25b constituting part of the second liquid chamber 21b to be described next are formed.

Next, descriptions are given of the first liquid chamber 21a and the second liquid chamber 21b.

As shown in FIGS. 5B and 5C, the first liquid chamber 21a is formed between the first flexible member 17 and the circular plate portion 7b of the second magnetic body 7. Also, the second liquid chamber 21b is formed between the second flexible member 18 and the circular plate portion 7b of the second magnetic body 7.

Also, as shown in FIG. 5A, the first orifice flow channels 25a constituting part of the first liquid chamber 21a are formed between the first magnetic body 6 (the radially-extending partitioning portions 6c) and the circular plate portion 7b of the second magnetic body 7, at portions where the support portion 16 is absent.

Also, as shown in FIG. 5A, the second orifice flow channels 25b constituting part of the second liquid chamber 21b are located on the outer circumferential side (radially outward) of the first orifice flow channels 25a and are formed between the first magnetic body 6 (the radially-extending partitioning portions 6c) and the circular plate portion 7b of the second magnetic body 7, at portions where the support portion 16 is absent.

In other words, as denoted by the hidden line (dotted line) in FIG. 7, the first orifice flow channels 25a are formed at the radially-extending partitioning portions 6c of the first magnetic body 6, at portions partitioning the slit S6 and the slit S7.

Meanwhile, as denoted by the hidden line (dotted line) in FIG. 7, the second orifice flow channels 25b are formed at the radially-extending partitioning portions 6c of the first magnetic body 6, at portions partitioning the slit S5 and the slit S8.

The radial width of the first orifice flow channels 25a is the same as those of the slits S6 and S7, and the radial width of the second orifice flow channels 25b is the same as those of the slits S5 and S8.

Also, as shown in FIG. 5A, the axial width of the first orifice flow channels 25a and the second orifice flow channels 25b are set to be equal to the distance between the first magnetic body 6 (the radially-extending partitioning portions 6c) and the circular plate portion 7b of the second magnetic body 7.

As shown in FIG. 7, the first liquid chamber 21a and the second liquid chamber 21b thus configured form two inner and outer annular chambers to be filled with magnetic viscoelastic fluid 20b, with the first liquid chambers 21a being radially inward of the second liquid chambers 21b.

Fluid that can be favorably used as the magnetic viscoelastic fluid 20b to fill the first liquid chamber 21a and the second liquid chamber 21b is, e.g., publicly known magneto-rheological fluid (MRF) or magneto-rheological compound (MRC), which has magnetic particles suspended in mineral oil, synthetic oil, or the like.

Next, descriptions are given of the first electromagnetic coil 10a and the second electromagnetic coil 10b shown in FIG. 4.

As shown in FIG. 4, the first electromagnetic coil 10a is ring-shaped.

As described earlier, the first electromagnetic coil 10a is situated between the hollow cylindrical portion 7a of the second magnetic body 7 (see FIG. 5A) and the first vertical wall 61 of the first magnetic body 6 (see FIG. 5A).

As shown in FIG. 4, the second electromagnetic coil 10b is ring-shaped and larger in diameter than the first electromagnetic coil 10a.

As described earlier, the second electromagnetic coil 10b is disposed between the outer wall 71 of the second magnetic body 7 (see FIG. 5A) and the second vertical wall 62 of the first magnetic body 6 (see FIG. 5A).

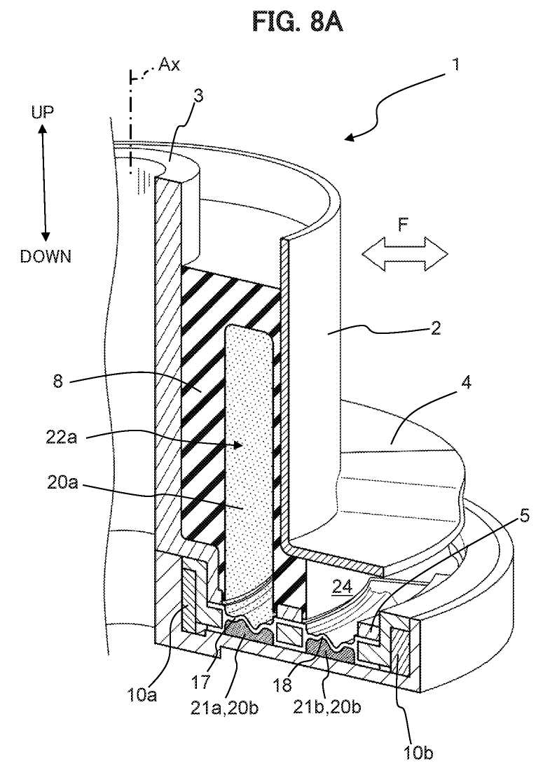

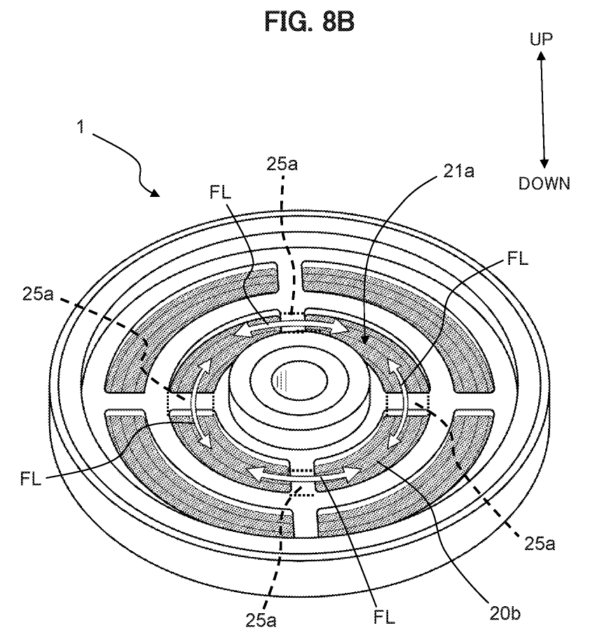

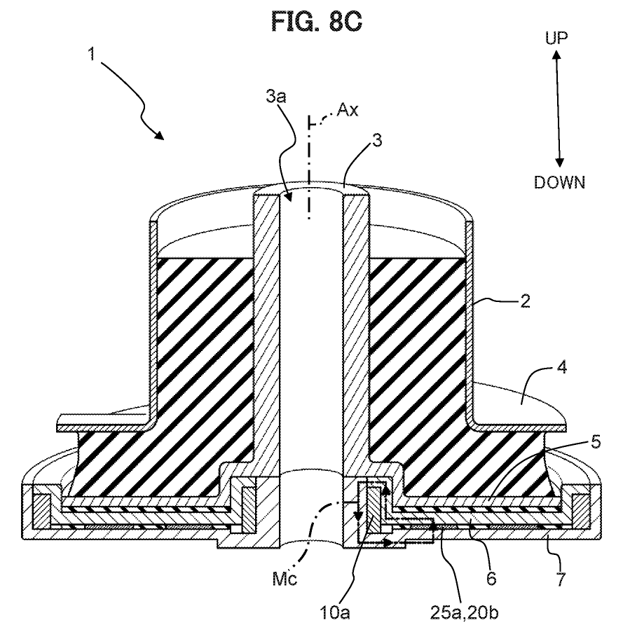

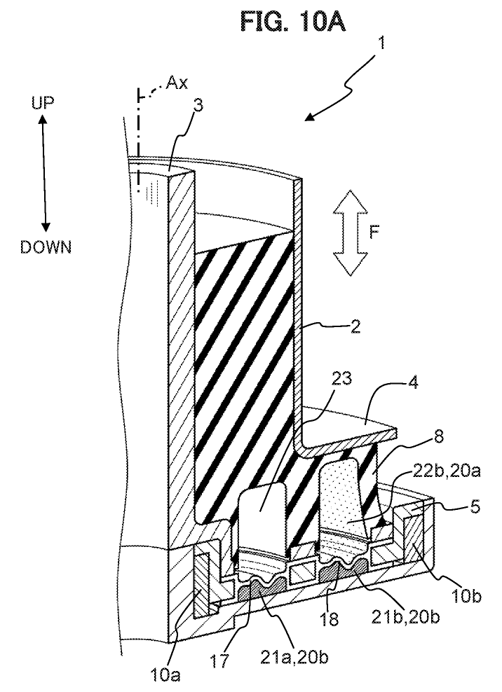

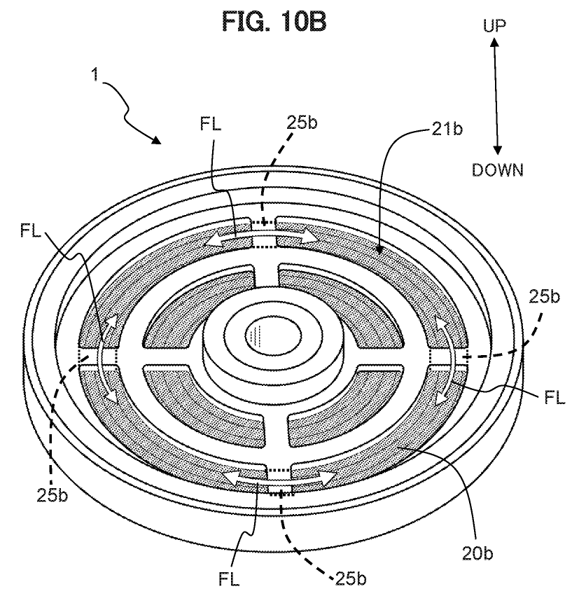

Then, the first electromagnetic coil 10a and the second electromagnetic coil 10b shown in FIG. 5A form, with the magnetic fields generated thereby, a magnetic path Mc (see FIGS. 8C and 10C) to be described later that runs through the first magnetic body 6 and the second magnetic body 7 shown in FIG. 5A as well as the magnetic viscoelastic fluid 20b (see FIG. 7) in the first orifice flow channels 25a and the second orifice flow channels 25b.

Next, an example of the method for assembling the active vibration isolation device 1 is described.

As shown in FIG. 4, in this assemblage method, an assembly of the outer hollow cylinder 2 having the outer-hollow-cylinder flange 4 and the inner hollow cylinder 3 having the inner-hollow-cylinder flange 5 joined by the elastic body 8 by vulcanized adhesion is prepared. Also, in this assemblage method, the first magnetic body 6 having the first flexible member 17 and the second flexible member 18 integrally formed therewith is prepared.

Next, in this assemblage method, as shown in FIG. 5A, the inner-hollow-cylinder flange 5 is pushed into the inner circumferential side of the second vertical wall 62 of the first magnetic body 6, while the protruding portion 6a of the first magnetic body 6 is pushed into the inner circumferential side of the stepped wall 5a of the inner-hollow-cylinder flange 5. As a result, the inner-hollow-cylinder flange 5 and the first magnetic body 6 are fixed. In this event, as shown in FIG. 5C, the third liquid chambers 22a are filled with non-magnetic liquid 20a in a liquid-tight manner. Also, as shown in FIG. 5B, the fourth liquid chambers 22b are filled with the non-magnetic liquid 20a in a liquid-tight manner, and the air chambers 23 are sealed airtightly.

Next, the second vertical wall 62 of the first magnetic body 6 supporting the inner-hollow-cylinder flange 5 is pushed into the inner circumferential side of the outer wall 71 of the second magnetic body 7, and the hollow cylindrical portion 7a of the second magnetic body 7 is pushed into the penetration hole 6f of the first magnetic body 6. As a result, the first magnetic body 6 and the second magnetic body 7 are fixed. In this event, as shown in FIG. 5B, the first electromagnetic coil 10a and the second electromagnetic coil 10b are situated at the predetermined positions described earlier, and the first liquid chamber 21a and the second liquid chamber 21b are filled with the magnetic viscoelastic fluid 20b in a liquid-tight manner. With this, assemblage of the active vibration isolation device 1 is completed.

### Operation of the Active Vibration Isolation Device

Next, the operation of the active vibration isolation device 1 is described.

FIG. 8A is a diagram illustrating how the active vibration isolation device 1 operates when an external force F such as a vibration is inputted in the transverse direction of the active vibration isolation device 1. FIG. 8B is a diagram illustrating the operation of the active vibration isolation device 1, showing how the magnetic viscoelastic fluid 20b flows in the first liquid chamber 21a when the external force F (see FIG. 8A) such as a vibration is inputted in the transverse direction of the active vibration isolation device 1. FIG. 8C is a diagram illustrating the operation of the active vibration isolation device 1, showing how the magnetic path Mc is formed by the magnetic field generated by the first electromagnetic coil 10a.

First, a description is given of how the active vibration isolation device 1 operates with the first electromagnetic coil 10a and the second electromagnetic coil 10b shown in FIG. 8A not being energized.

In the active vibration isolation device 1 shown in FIG. 8A, the inner hollow cylinder 3 is elastically supported by the elastic body 8 inside the outer hollow cylinder 2.

Thus, in the transverse direction, as shown in FIG. 8A, when the external force F such as a vibration is inputted to the inner hollow cylinder 3 in the transverse direction as denoted by the white arrow, the relative positions of the inner hollow cylinder 3 and the outer hollow cylinder 2 change radially.

In a case where in FIG. 8A, the outer hollow cylinder 2 changes in position toward the inner hollow cylinder 3 as seen from the side from which the external force F is inputted, which is one of the directions pointed by the white arrow indicating application of the external force F, the outer hollow cylinder 2 pushes the elastic body 8 defining the third liquid chambers 22a between itself and the inner hollow cylinder 3. This increases the liquid pressure of the non-magnetic liquid 20a in the third liquid chambers 22a.

Once the liquid pressure of the non-magnetic liquid 20a in the third liquid chambers 22a is increased, the non-magnetic liquid 20a pushes the first flexible member 17 toward the first liquid chamber 21a.

The magnetic viscoelastic fluid 20b filling the first liquid chamber 21a is thereby increased in liquid pressure.

Meanwhile, as shown in FIG. 7, the first liquid chamber 21a forms an annular chamber filled with the magnetic viscoelastic fluid 20b with the first orifice flow channels 25a interposed thereon.

Also, as shown in FIG. 5B, the first liquid chamber 21a is adjacent to the air chambers 23 filled with a compressible gas with the first flexible member 17 interposed in between. Thus, the magnetic viscoelastic fluid 20b with the increased liquid pressure in the first liquid chamber 21a pushes the first flexible member 17 toward the air chambers 23, the first flexible member 17 partitioning the first liquid chamber 21a and the air chambers 23. This compresses the gas in the air chambers 23, and the first flexible member 17 bulges toward the air chambers 23.

Conversely, in a case where the outer hollow cylinder 2 shown in FIG. 8A changes in position away from the inner hollow cylinder 3, the outer hollow cylinder 2 pulls the elastic body 8 between itself and the inner hollow cylinder 3. This decreases the liquid pressure of the non-magnetic liquid 20a in the third liquid chambers 22a.

Once the liquid pressure of the non-magnetic liquid 20a in the third liquid chambers 22a is decreased, the first flexible member 17 is pulled toward the third liquid chambers 22a.

The magnetic viscoelastic fluid 20b filling the first liquid chamber 21a is thereby decreased in liquid pressure.

The magnetic viscoelastic fluid 20b with the decreased liquid pressure in the first liquid chamber 21a draws the first flexible member 17 shown in FIG. 5B into the first liquid chamber 21a from the air chamber side.

This expands the gas in the air chambers 23, and the first flexible member 17 bulges toward the first liquid chamber 21a.

Then, such change in position of the first flexible member 17 caused by the change in the relative positions of the outer hollow cylinder 2 and the inner hollow cylinder 3 shown in FIG. 8A causes the magnetic viscoelastic fluid 20b filling the first liquid chamber 21a to flow as denoted by flow FL as shown in FIG. 8B, passing through the first orifice flow channels 25a.

The active vibration isolation device 1 exhibits damping characteristics against the inputted external F (see FIG. 8A) using the flow resistance produced when the magnetic viscoelastic fluid 20b passes through the first orifice flow channels 25a.

Next, a description is given of how the active vibration isolation device 1 (see FIG. 8A) operates with the first electromagnetic coil 10a being energized (see FIG. 8A).

As shown in FIG. 8C, by the magnetic field generated by the energized first electromagnetic coil 10a, the magnetic path Mc is formed in the first magnetic body 6 and the second magnetic body 7, running through the magnetic viscoelastic fluid 20b in the first orifice flow channels 25a.

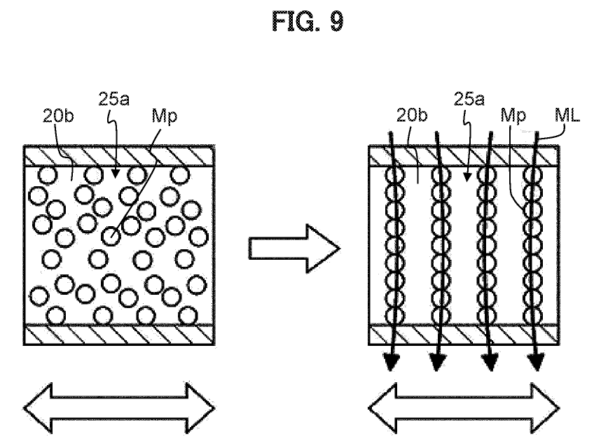

FIG. 9 is a schematic diagram showing how the magnetic particles Mp behave when a magnetic field is applied to the first orifice flow channels 25a.

As shown in the left diagram in FIG. 9, in a state where no magnetic field is applied, the magnetic viscoelastic fluid 20b in the first orifice flow channels 25a in the first liquid chamber 21a maintains the dispersion of the magnetic particles Mp and exhibits predetermined fluidity.

Compared to this, when the magnetic path Mc (see FIG. 8C) is formed by a magnetic field generated, the magnetic particles Mp align along a magnetic flux ML as shown in the right diagram in FIG. 9. As a result, the apparent viscosity of the magnetic viscoelastic fluid 20b increases, and also, the aligned magnetic particles Mp act as a valve element, producing flow resistance in the first orifice flow channels 25a.

The active vibration isolation device 1 exhibits damping characteristics against the inputted external force (see FIG. 8A) using the flow resistance of the magnetic viscoelastic fluid 20b in the first orifice flow channels 25a caused by the generated magnetic field.

Then, the damping characteristics of the active vibration isolation device 1 against the external force such as a vibration can be varied by control of the value of current flowing through the first electromagnetic coil 10a (see FIG. 8C) according to the magnitude of the inputted external force.

Next, a description is given of how the active vibration isolation device 1 operates when a vibration or the like is inputted in the axial direction of the active vibration isolation device 1.

FIG. 10A is a diagram illustrating how the active vibration isolation device 1 operates when the external force F such as a vibration is inputted in the axial direction of the active vibration isolation device 1. FIG. 10B is a diagram illustrating the operation of the active vibration isolation device 1, showing how the magnetic viscoelastic fluid 20b flows in the second liquid chamber 21b when the external force F such as a vibration (see FIG. 10A) is inputted in the axial direction of the active vibration isolation device 1. FIG. 10C is a diagram illustrating the operation of the active vibration isolation device 1, showing how the magnetic path Mc is formed by the magnetic field generated by the second electromagnetic coil 10b.

In a case where in FIG. 10A, the outer hollow cylinder 2 changes in position downward, which is one of the directions pointed by the white arrow indicating application of the external force F, the outer-hollow-cylinder flange 4 pushes the elastic body 8 defining the fourth liquid chambers 22b between itself and the inner-hollow-cylinder flange 5. This increases the liquid pressure of the non-magnetic liquid 20a in the fourth liquid chambers 22b.

Once the liquid pressure of the non-magnetic liquid 20a in the fourth liquid chambers 22b is increased, the non-magnetic liquid 20a pushes the second flexible member 18 toward the second liquid chamber 21b.

The magnetic viscoelastic fluid 20b filling the second liquid chamber 21b is thereby increased in liquid pressure.

The magnetic viscoelastic fluid 20b with the increased liquid pressure in the second liquid chamber 21b pushes the second flexible member 18 toward the outer-rim depressed portions 24, the second flexible member 18 partitioning the second liquid chamber 21b and the outer-rim depressed portions 24 shown in FIG. 5C.

The second flexible member 18 bulges toward the outer-rim depressed portions 24 opened to the atmosphere.

Conversely, in a case where the outer hollow cylinder 2 shown in FIG. 10A changes in position upward, the outer-hollow-cylinder flange 4 pulls the elastic body 8 defining the fourth liquid chambers 22b between itself and the inner-hollow-cylinder flange 5. This decreases the liquid pressure of the non-magnetic liquid 20a in the fourth liquid chambers 22b.

Once the liquid pressure of the non-magnetic liquid 20a in the fourth liquid chambers 22b is decreased, the second flexible member 18 is pulled toward the fourth liquid chambers 22b.

The second flexible member 18 shown in FIG. 5C is drawn toward the second liquid chamber 21b. The second flexible member 18 bulges toward the second liquid chamber 21b.

Then, such change in position of the second flexible member 18 caused by the change in the relative positions of the outer-hollow-cylinder flange 4 and the inner-hollow-cylinder flange 5 shown in FIG. 10A causes the magnetic viscoelastic fluid 20b filling the second liquid chamber 21b to flow as denoted by flow FL as shown in FIG. 10B, passing through the second orifice flow channels 25b.

The active vibration isolation device 1 exhibits damping characteristics against the inputted external F (see FIG. 10A) using the flow resistance produced when the magnetic viscoelastic fluid 20b passes through the second orifice flow channels 25b.

Also, in the active vibration isolation device 1, as shown in FIG. 10C, by the magnetic field generated by the energized second electromagnetic coil 10b, the magnetic path Mc is formed in the first magnetic body 6 and the second magnetic body 7, running through the magnetic viscoelastic fluid 20b in the second orifice flow channels 25b.

The active vibration isolation device 1 thereby exhibits damping characteristics against the inputted external F (see FIG. 10A) using the flow resistance of the magnetic viscoelastic fluid 20b in the second orifice flow channels 25b produced by the generated magnetic field.

Then, the damping characteristics of the active vibration isolation device 1 against the external force such as a vibration can be varied by control of the current value flowing through the second electromagnetic coil 10b (see FIG. 10C) according to the magnitude of the inputted external force.

Also, to exhibit damping characteristics against a vibration or the like inputted in both of the axial direction and the transverse direction, the active vibration isolation device 1 of the present embodiment can control the magnitude of the magnetic field (the density of magnetic flux in the first magnetic body 6 and the second magnetic body 7) by changing the orientation of the magnetic field generated by the first electromagnetic coil 10a (see FIG. 5A) and the second electromagnetic coil 10b (see FIG. 5A) and adjusting the value of current passed through the first electromagnetic coil 10a (see FIG. 5A) and the second electromagnetic coil 10b (see FIG. 5A).

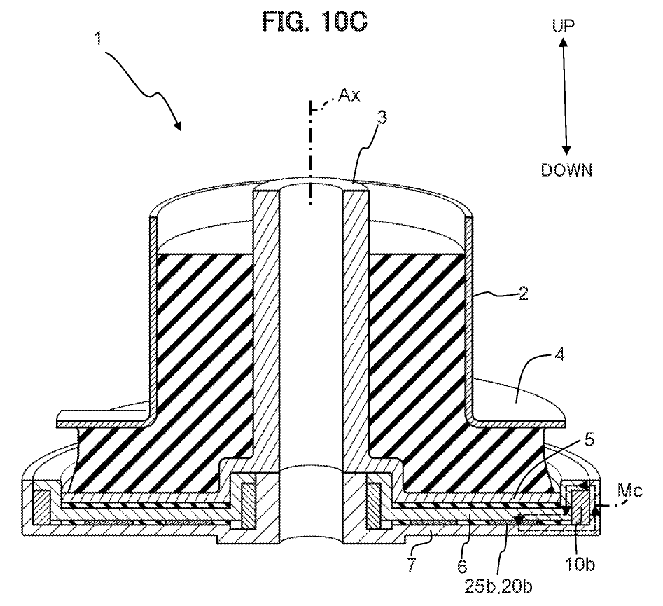

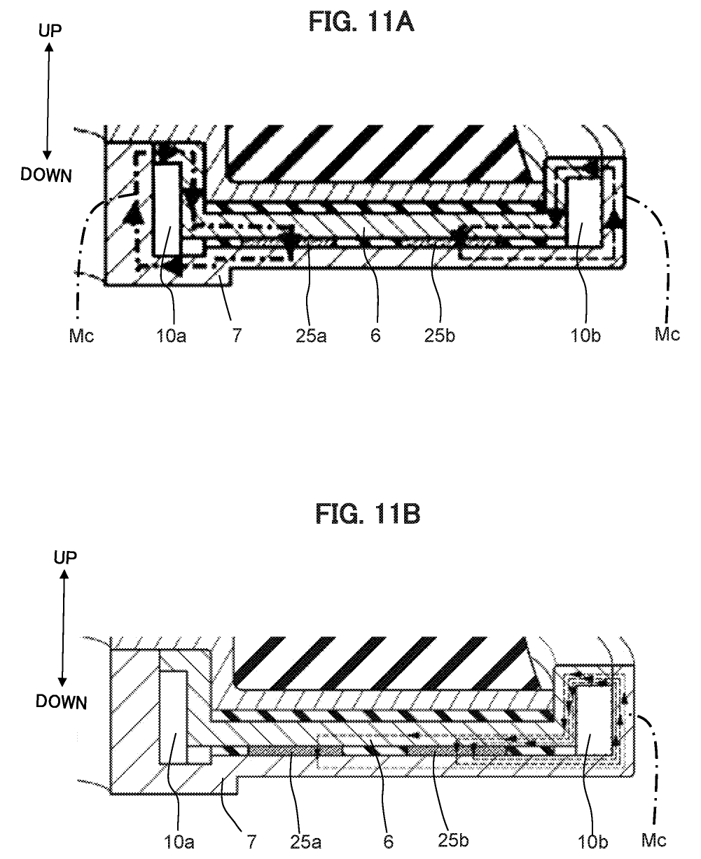

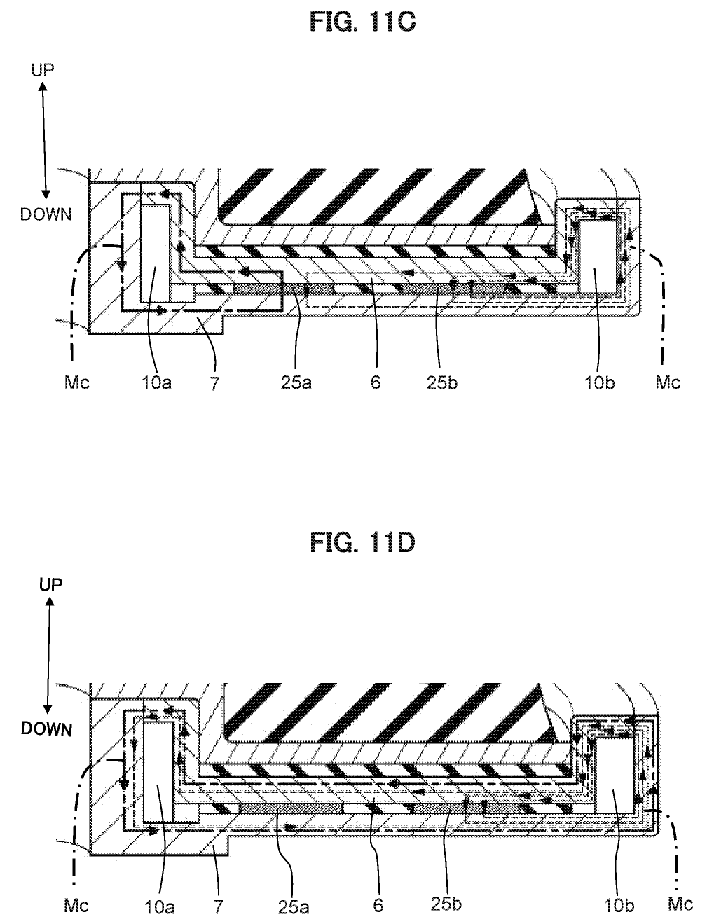

FIG. 11A is a diagram showing a first state of the magnetic path Mc that can be formed by the magnetic fields generated by the first electromagnetic coil 10a and the second electromagnetic coil 10b.

FIG. 11B is a diagram showing a second state of the magnetic path Mc that can be formed by the magnetic field generated by the second electromagnetic coil 10b.

FIG. 11C is a diagram showing a third state of the magnetic path Mc that can be formed by the magnetic fields generated by the first electromagnetic coil 10a and the second electromagnetic coil 10b.

FIG. 11D is a diagram showing a fourth state of the magnetic path Mc that can be formed by the magnetic fields generated by the first electromagnetic coil 10a and the second electromagnetic coil 10b.

In the diagram of the first state shown in FIG. 11A, the value and polarity of the current to each of the first electromagnetic coil 10a and second electromagnetic coil 10b are controlled so that the first electromagnetic coil 10a may form the magnetic path Mc only in the first orifice flow channels 25a and the second electromagnetic coil 10b may form the magnetic path Mc only in the second orifice flow channels 25b.

In the example in the diagram of the first state, the active vibration isolation device 1 can control the orientation and magnitude of the magnetic field in the first orifice flow channels 25a and the orientation and magnitude of the magnetic field in second orifice flow channels 25b separately and independently.

In the diagram of the second state shown in FIG. 11B, the magnetic path Mc is formed in the first orifice flow channels 25a and the second orifice flow channels 25b only by the second electromagnetic coil 10b.

Also, although not shown, the magnetic path Mc can also be formed in the first orifice flow channels 25a and the second orifice flow channels 25b only by the first electromagnetic coil 10a.

Thus, in the example in the diagram of the second state, the active vibration isolation device 1 can exhibit damping characteristics against both an external force inputted in the axial direction and an external force inputted in the transverse direction, should one of the first electromagnetic coil 10a and the second electromagnetic coil 10b be faulty.

In the diagram of the third state shown in FIG. 11C, the first electromagnetic coil 10a forms the magnetic path Mc only in the first orifice flow channels 25a, and the second electromagnetic coil 10b forms the magnetic path Mc not only in the second orifice flow channels 25b but also in the first orifice flow channels 25a. Then, current value and current polarity are controlled so that the orientation of the magnetic field generated in the first orifice flow channels 25a by the second electromagnetic coil 10b may be opposite from that of the magnetic field generated in the first orifice flow channels 25a by the first electromagnetic coil 10a.

Thus, in the example in the diagram of the third state, the magnetic field generated in the first orifice flow channels 25a by the first electromagnetic coil 10a and the magnetic field generated in the first orifice flow channels 25a generated by the second electromagnetic coil 10b interfere with each other.

The second electromagnetic coil 10b can contribute to control of the damping characteristics against an external force inputted in the transverse direction.

Also, although not shown, the active vibration isolation device 1 can be configured so that the magnetic field generated in the second orifice flow channels 25b by the second electromagnetic coil 10b and the magnetic field generated in the second orifice flow channels 25b by the first electromagnetic coil 10a may interfere with each other. This allows the active vibration isolation device 1 to contribute to control of the damping characteristics against an external force inputted in the axial direction.

In the diagram of the fourth state shown in FIG. 11D, the magnetic field generated in the first orifice flow channels 25a by the first electromagnetic coil 10a and the magnetic field generated in the first orifice flow channels 25a by the second electromagnetic coil 10b interfere with and cancel out each other, resulting in that the magnetic path Mc is not formed in the first orifice flow channels 25a.

Thus, in the example in the diagram of the fourth state, the active vibration isolation device 1 is specifically configured to control the damping characteristics against an external force inputted in the axial direction.

Also, although not shown, the active vibration isolation device 1 may be configured so that the magnetic field generated in the second orifice flow channels 25b by the second electromagnetic coil 10b and the magnetic field generated in the second orifice flow channels 25b by the first electromagnetic coil 10a interfere with and cancel out each other, resulting in that the magnetic path Mc is not formed in the second orifice flow channels 25b.

Thus, the active vibration isolation device 1 is specifically configured to control the damping characteristics against an external force inputted in the transverse direction.

### Operational Effects

Next, a description is given of the operational effects achieved by the active vibration isolation device 1.

The active vibration isolation device 1 of the present embodiment is the active vibration isolation device 1 having the outer hollow cylinder 2, the inner hollow cylinder 3 situated on the inner circumferential side of the outer hollow cylinder 2, magnetic field generation portions (the first electromagnetic coil 10a and the second electromagnetic coil 10b) that generate a magnetic field, magnetic bodies (the first magnetic body 6 and the second magnetic body 7) where the magnetic path Mc is formed by the magnetic field, the first liquid chamber 21a and the second liquid chamber 21b filled with the magnetic viscoelastic fluid 20b, the third liquid chamber 22a adjacent to the first liquid chamber 21a in the direction of the axis of the inner hollow cylinder 3 and filled with the non-magnetic liquid 20a, and the fourth liquid chamber 22b adjacent to the second liquid chamber 21b in the direction of the axis of the inner hollow cylinder 3 and filled with the non-magnetic liquid 20a. The first liquid chamber 21a and the third liquid chambers 22a are partitioned by the first flexible member 17, and the second liquid chamber 21b and the fourth liquid chambers 22b are partitioned by the second flexible member 18. A first one of the third liquid chambers 22a and the fourth liquid chambers 22b is provided between the outer hollow cylinder 2 and the inner hollow cylinder 3 so that it can be pushed in the transverse direction, and a second one of the liquid chambers is provided radially outward of the outer hollow cylinder 2 so that it can be pushed in the axial direction. Part of the first liquid chamber 21a and part of the second liquid chamber 21b each form a flow channel (the first orifice flow channel 25a and the second orifice flow channel 25b) for the magnetic viscoelastic fluid 20b located on the magnetic path Mc.

According to the active vibration isolation device 1 thus configured, when the magnetic field generation portions (the first electromagnetic coil 10a and the second electromagnetic coil 10b) generate a magnetic field, the viscosity of the magnetic viscoelastic fluid 20b is increased, which makes it harder for the magnetic viscoelastic fluid 20b to flow through the flow channels (the first orifice flow channel 25a and the second orifice flow channel 25b). The active vibration isolation device 1 thus exhibits rigidity against an external force such as a vibration inputted thereto.

Also, according to the active vibration isolation device 1, when the magnetic field generation portions (the first electromagnetic coil 10a and the second electromagnetic coil 10b) do not generate a magnetic field, the viscosity of the magnetic viscoelastic fluid 20b is decreased, which makes it easier for the magnetic viscoelastic fluid 20b to move through the flow channels (the first orifice flow channel 25a and the second orifice flow channel 25b) in a direction from a position receiving load due to an external force to a position not receiving the load. The active vibration isolation device 1 can thereby reduce its rigidity against an external force such as a vibration inputted thereto.

The active vibration isolation device 1 can actively exhibit damping characteristics against an external force such as a vibration inputted thereto by adjusting the magnitude of the magnetic fields generated by the magnetic field generation portions (the first electromagnetic coil 10a and the second electromagnetic coil 10b) according to the magnitude of the external force inputted thereto.

Also, in the active vibration isolation device 1 thus configured, when an external force is inputted in the transverse direction (the radial direction), one of the third liquid chambers 22a and the fourth liquid chambers 22b provided between the outer hollow cylinder 2 and the inner hollow cylinder 3 is pushed, increasing the liquid pressure of the non-magnetic liquid 20a.

The non-magnetic liquid 20a with the increased liquid pressure increases the liquid pressure of the magnetic viscoelastic fluid 20b in one of the first liquid chamber 21a and the second liquid chamber 21b via one of the first flexible member 17 and the second flexible member 18.

Thus, the magnetic viscoelastic fluid 20b moves through the flow channel (the first orifice flow channel 25a and the second orifice flow channel 25b) in a direction from a location receiving a load due to the external force to a location not receiving the load.

In this event, the active vibration isolation device 1 (e.g., the bush 35 (see FIG. 1)) can exhibit damping characteristics as described above based on the magnitude of the magnetic field generated by the magnetic field generation portion (the first electromagnetic coil 10a and the second electromagnetic coil 10b).

Also, in the active vibration isolation device 1 thus configured, when an external force is inputted in the axial direction, the other one of the third liquid chamber 22a and the fourth liquid chamber 22b provided between the outer hollow cylinder 2 and the inner hollow cylinder 3 is pushed, increasing the liquid pressure of the non-magnetic liquid 20a. The non-magnetic liquid 20a with the increased pressure then increases the liquid pressure of the magnetic viscoelastic fluid 20b in the other one of the first liquid chamber 21a and the second liquid chamber 21b via the other one of the first flexible member 17 and the second flexible member 18.

Thus, the magnetic viscoelastic fluid 20b moves through the flow channel (the first orifice flow channel 25a and the second orifice flow channel 25b) in a direction from a location receiving a load due to the external force to a location not receiving the load.

In this event, the active vibration isolation device 1 (e.g., the bush 35 (see FIG. 1)) can exhibit damping characteristics as described above based on the magnitude of the magnetic field generated by the magnetic field generation portion (the first electromagnetic coil 10a and the second electromagnetic coil 10b).

Also, in this active vibration isolation device 1, the first liquid chamber 21a, the second liquid chamber 21b, the first flexible member 17, and the second flexible member 18 can be designed to extend circumferentially.

According to the active vibration isolation device 1 thus designed, the active vibration isolation device 1 can be compact in size while maintaining favorable response performance against an external force such as a vibration inputted thereto.

Also, this active vibration isolation device 1 can be configured such that the first liquid chamber 21a is disposed closer to the inner hollow cylinder 3 than the second liquid chamber 21b is, and the magnetic field generation portion has a first magnetic field generation portion (the first electromagnetic coil 10a) disposed closer to the inner hollow cylinder 3 than the first liquid chamber 21a is and a second magnetic field generation portion (the second electromagnetic coil 10b) disposed outward of the second liquid chamber 21b in the radial direction of the inner hollow cylinder 3, the first and second magnetic field generation portions being configured to apply a magnetic force to the first liquid chamber 21a and the second liquid chamber 21b.

The active vibration isolation device 1 thus configured can control the viscosity of the magnetic viscoelastic fluid 20b in each of the liquid chambers (the first liquid chamber 21a and the second liquid chamber 21b) and therefore can precisely control its damping characteristics as needed.

Also, in this active vibration isolation device 1, the first and second magnetic field generation portions are formed of electromagnetic coils (the first electromagnetic coil 10a and the second electromagnetic coil 10b) and are provided at positions facing each other, and the active vibration isolation device 1 can be configured to be able to adjust the magnitude and orientation of their magnetic fields by controlling the values of current applied to the electromagnetic coils and switching the energization polarity.

The active vibration isolation device 1 thus configured can control the damping characteristics independently against an external force inputted in the axial direction and an external force inputted in the transverse direction by controlling the orientation of the magnetic fields generated by the first electromagnetic coil 10a and the second electromagnetic coil 10b.

Also, the active vibration isolation device 1 thus configured can control the interference between the magnetic fields generated by the first electromagnetic coil 10a and the second electromagnetic coil 10b by controlling the orientation of the magnetic fields.

Also, this active vibration isolation device 1 can be configured such that the first liquid chamber 21a, the third liquid chambers 22a, and the first flexible member 17 are situated to align axially and the second liquid chamber 21b, the fourth liquid chambers 22b, and the second flexible member 18 are situated to align axially.

By thus being configured such that the above-described chambers such as the first liquid chamber 21a are arranged axially, the active vibration isolation device 1 can efficiently cause the magnetic viscoelastic fluid 20b to flow.

Also, this active vibration isolation device 1 can be configured such that the active vibration isolation device 1 includes the outer-hollow-cylinder flange 4 extending radially outward from one axial end of the outer hollow cylinder 2 and the inner-hollow-cylinder flange 5 extending radially outward from the inner hollow cylinder 3 and located away from the outer-hollow-cylinder flange 4 axially, and the other liquid chamber (the other one of the third liquid chamber 22a and the fourth liquid chamber 22b) is formed in such a manner as to be sandwiched between the inner-hollow-cylinder flange 5 and the outer-hollow-cylinder flange 4.

The active vibration isolation device 1 thus configured can exhibit the damping characteristics against an external force inputted in the axial direction (the longitudinal direction) accurately and independently using the other liquid chamber (the other one of the third liquid chamber 22a and the fourth liquid chamber 22b).

The active vibration isolation device 1 of the present embodiment can be favorably used to replace various conventional components such as a mount bush and a suspension bush that need to be carefully determined considering safety performance, kinematic performance, comfort performance, ride comfort performance, and the like.

The present embodiment has been described above, but the present invention is not limited to the above embodiment and can be implemented in various modes.

### First Modification

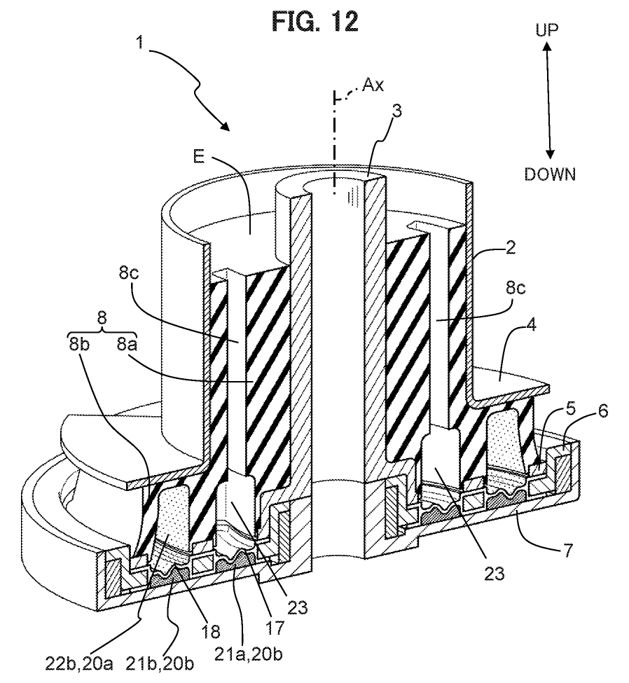

FIG. 12 is a partial perspective view of the active vibration isolation device 1 according to a first modification.

Note that components in the first modification that are the same as those in the above embodiment are denoted using the same reference numerals and are not described in detail.

In the active vibration isolation device 1 of the above embodiment (see FIG. 5B), the air chambers 23 are formed in the elastic body 8 as closed spaces.

As shown in FIG. 12, in the active vibration isolation device 1 according to the first modification, the air chambers 23 each communicate with the atmosphere through a communication hole 8c.

Specifically, in the active vibration isolation device 1 according to the first modification, the elastic body 8 is situated between the outer hollow cylinder 2 and the inner hollow cylinder 3 and between the outer-hollow-cylinder flange 4 and the inner-hollow-cylinder flange 5, and the air chambers 23 are provided adjacent to the first liquid chamber 21a with the first flexible member 17 interposed in between. The air chambers 23 are formed within the elastic body 8 and communicate with the atmosphere through the communication holes 8c provided in the elastic body 8.

Note that although the communication holes 8c are assumed to be open at the exposed end surface E of the elastic body 8 in the example shown, the communication hole 8c may be provided in such a manner as to penetrate through the outer hollow cylinder 2 via the elastic body 8.

The active vibration isolation device 1 according to the first modification can exhibit damping characteristics against an external force inputted in the transverse direction with even better responsiveness.

### Second Modification

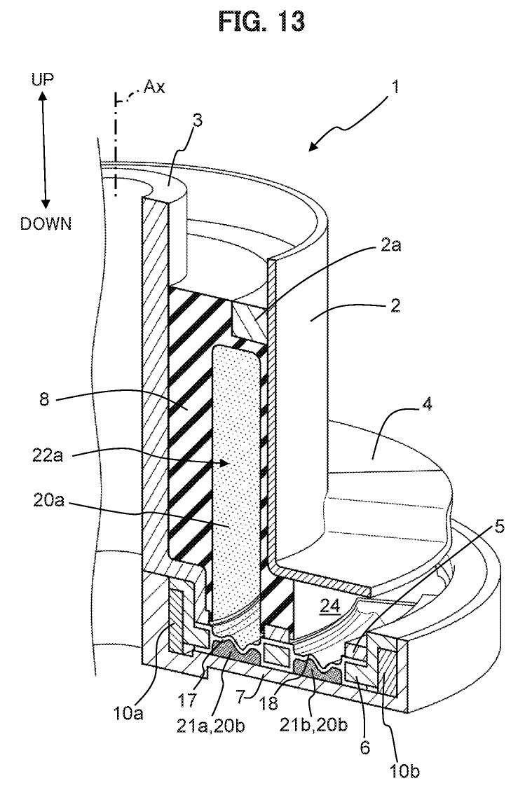

FIG. 13 is a partial perspective view of the active vibration isolation device 1 according to a second modification.

Note that components in the second modification that are the same as those in the above embodiment are denoted using the same reference numerals and are not described in detail.

As shown in FIG. 13, the active vibration isolation device 1 according to the second modification has a rib 2a protruding from the inner circumferential surface of the outer hollow cylinder 2 toward the elastic body 8 and being axially away from the third liquid chambers 22a.

In this active vibration isolation device 1 according to the second modification, the third liquid chambers 22a, which handle an external force inputted in the transverse direction in the embodiment, can also handle an external force inputted in the axial direction owing to the rib 2a.

In the above embodiment, as shown in FIGS. 5B and 5C, the second liquid chamber 21b and the fourth liquid chambers 22b are located more toward the outer circumferential side than the first liquid chamber 21a and the third liquid chambers 22a.

However, the active vibration isolation device 1 can be configured such that one of each third liquid chamber 22a and each fourth liquid chamber 22b is provided between the outer hollow cylinder 2 and the inner hollow cylinder 3 and the other one is provided on the outer circumferential side of the outer hollow cylinder 2.

Thus, although not shown, conversely to the above embodiment, the active vibration isolation device 1 can be configured such that the second liquid chamber 21b and the fourth liquid chambers 22b are located on the inner circumferential side and the first liquid chamber 21a and the third liquid chambers 22a are located on the outer circumferential side.

Also, although the outer-rim depressed portions 24 (see FIG. 5C) are open to the atmosphere in the above embodiment, the outer-rim depressed portions 24 can be formed as closed spaces within the elastic body 8 between the outer-hollow-cylinder flange 4 and the inner-hollow-cylinder flange 5.

Also, the active vibration isolation device 1 is assumed to be situated with its axial direction extending along the up-down direction (the vertical direction) in the above embodiment, but the orientation of the axial direction of the active vibration isolation device 1 is not limited to this. The axial direction of the active vibration isolation device 1 may be along the horizontal direction or along a slanted direction.

What is claimed is:

1. An active vibration isolation device comprising:
an outer hollow cylinder;
an inner hollow cylinder situated at an inner circumferential side of the outer hollow cylinder;
a magnetic field generation portion configured to generate a magnetic field;
a magnetic body where a magnetic path is formed by the magnetic field;
a first liquid chamber and a second liquid chamber that are filled with magnetic viscoelastic fluid,
a third liquid chamber adjacent to the first liquid chamber in an axial direction of the inner hollow cylinder and filled with non-magnetic liquid; and
a fourth liquid chamber adjacent to the second liquid chamber in the axial direction of the inner hollow cylinder and filled with non-magnetic liquid, wherein
the first liquid chamber and the third liquid chamber are partitioned by a first flexible member,
the second liquid chamber and the fourth liquid chamber are partitioned by a second flexible member,
a first one of the third liquid chamber and the fourth liquid chamber is provided between the outer hollow cylinder and the inner hollow cylinder so as to be able to be pushed in a transverse direction perpendicular to the axial direction,
a second one of the third liquid chamber and the fourth liquid chamber is provided radially outward of the outer hollow cylinder so as to be able to be pushed in the axial direction, and
part of the first liquid chamber and part of the second liquid chamber form a flow channel for the magnetic viscoelastic fluid located above the magnetic path.

2. The active vibration isolation device according to claim 1, wherein
the first liquid chamber, the second liquid chamber, the first flexible member, and the second flexible member extend circumferentially.

3. The active vibration isolation device according to claim 1, wherein
the first liquid chamber is situated closer to the inner hollow cylinder than the second liquid chamber is, and
the magnetic field generation portion has
a first magnetic field generation portion situated closer to the inner hollow cylinder than the first liquid chamber is and configured to generate a magnetic field in each of the first liquid chamber and the second liquid chamber and
a second magnetic field generation portion situated outward of the second liquid chamber in a radial direction of the inner hollow cylinder.

4. The active vibration isolation device according to claim 3, wherein
the first magnetic field generation portion and the second magnetic field generation portion are configured as electromagnetic coils and provided at positions facing each other, and
magnitude and orientation of the magnetic field of each of the electromagnetic coils are adjustable by control of a value of current applied to the electromagnetic coil and switching of energization polarity.

5. The active vibration isolation device according to claim 1, wherein
the first liquid chamber, the third liquid chamber, and the first flexible member are situated to align in the axial direction, while the second liquid chamber, the fourth liquid chamber, and the second flexible member are situated to align in the axial direction.

6. The active vibration isolation device according to claim 1, comprising:
an outer-hollow-cylinder flange extending radially outward from an axial end of the outer hollow cylinder and
an inner-hollow-cylinder flange extending radially outward from the inner hollow cylinder and situated away from the outer-hollow-cylinder flange in the axial direction, wherein
the second one of the third liquid chamber and the fourth liquid chamber is formed in such a manner as to be sandwiched between the inner-hollow-cylinder flange and the outer-hollow-cylinder flange.
